(19) United States
(12) Patent Application Publication
(10) Pub. No.: US 2012/0014114 A1
(43) Pub. Date: Jan. 19, 2012

(54) GOBO PROJECTOR AND MOVING HEAD

(75) Inventors: Adrianus Hendricus Johannes Van Den Brandt, Turnhout (BE); Rudi Marie Jozef Wils, Turnhout (BE)

(73) Assignee: KONINKLIJKE PHILIPS ELECTRONICS N.V., EINDHOVEN (NL)

(21) Appl. No.: 13/259,794

(22) PCT Filed: Mar. 18, 2010
(86) PCT No.: PCT/IB2010/051180

§ 371 Date: Sep. 23, 2011

(30) Foreign Application Priority Data
Mar. 27, 2009 (EP) 09156478.1

(51) Int. Cl. F21V 5/04

(52) U.S. Cl. 362/311.01

(57) ABSTRACT

The invention proposes a gobo projector (10) comprising a light source (100), a gobo holder (400) having a gobo open aperture (401) and a projection lens (500), wherein the light source is a high-pressure metal halide discharge lamp having an arc length, wherein the gobo projector has an overall efficacy of at least 25 lm/W. Advantageously, such gobo projector can be relatively small, while still having a relatively high efficacy. Further, such gobo projector may have a relatively high CRI, relatively high CCT, and may have a relatively small gobo open aperture.

### FIELD OF THE INVENTION

The invention relates to a gobo projector comprising a light source, a gobo holder having a gobo open aperture and a projection lens, as well as to a moving head comprising a gobo projector.

### BACKGROUND OF THE INVENTION

The term “GOBO” (further indicated as gobo) is defined in the art as “go between optics” or “goes before optics” or “graphical optical blackout”. A gobo is a template or pattern cut into a circular plate used to create patterns of projected light. Gobos control light by blocking, coloring, or diffusing some portion of the beam before it reaches the lens. Because the light is shaped before it is focused, hard-edged images can be projected over short distances.

A theatrical gobo may for instance be made from either sheet metal or borosilicate glass, depending upon the complexity of the design. Glass gobos can include colored areas (much like stained glass windows), made of multiple layers of dichroic glass, one for each color glued on an aluminium or chrome coated black and white gobo. New technologies make it possible to turn a color photo into a glass gobo.

Gobo projectors are used both indoors and outdoors. As gobo projection systems are typically used for entertainment or to attract attention of the public, typically the images are moving, rotating, and/or interchanged.

Gobo projectors (including moving head projectors) are known in the art, and are for instance described in U.S. Pat. No. 5,113,332 and U.S.2008/0062692. An example of a moving head projector is a gobo projector held in a yoke, so that tilting and/or rotation can be varied.

U.S.2008/0062692 describes moving head projectors comprising a base, to which base a yoke is rotationally connected, which yoke is rotationally connected to a head, which head comprises a light source placed partly inside reflective means, which reflective means form a light beam, which light beam passes through light forming means, which light beam furthermore passes through at least one lens before the light beam leaves the projector.

### SUMMARY OF THE INVENTION

The invention proposes, in order to obtain a gobo projector with a high overall efficacy (or system efficacy), to equip gobo projectors with high-pressure metal halide discharge lamps having a reduced arc length. In an embodiment, ultra-high performance (UHP) lamps are suggested. Gobo projectors with short arc UHP lamps, especially in combination with a homogenizing device, may have a high efficacy, a good or even high color rendering index (CRI), a high correlated color temperature (CCT), and a relatively homogeneous light distribution on the gobo, while nevertheless relatively small gobo open apertures may be applied. Surprisingly, UHP lamps with a high Hg pressure have a high CRI. Moreover, this high CRI is maintained in the light collected into the etendue of the gobo projector as it turns out that UHP lamps suffer little or not at all from color de-mixing in the discharge vessel. In another embodiment, a high-pressure metal halide lamp is proposed, with a reduced arc length, and having a specific filling (see below). Gobo projectors with such lamps, optionally in combination with a homogenizing device, may have a high efficacy, a good or even high CRI, a high CCT, a relatively homogeneous light distribution on the gobo, while nevertheless relatively small gobo open apertures may be applied.

Hence, a relatively efficient and high-performance gobo projector is suggested, that may even have a reduced unit size (such as because of the reduced gobo open aperture).

Typically the most important specification points of (prior-art) gobo projectors, next to all kind of (dynamic) features, are high light output (measured in lumen), low power usage (measured in Watt), (and thereby the luminous efficacy in lumen/Watt), small physical size (in litre, cc, m³ or cubic feet), low weight (in kg), high CCT, and high CRI.

Today's gobo projection systems and moving heads may score well on some specification points but not on all. Below, some prior-art examples are given:

| | Example 1 | Example 2 | Example 3 |
|---|---|---|---|
| Type of lamp | Halogen | HID | HID |
| Light output (lm) | 5000 | 5000 | 16700 |
| Lamp power (W) | 250 | 250 | 700 |
| Overall efficacy | 20 | 20 | 24 |
| (lm/W) | | | |
| CCT (K) | 3000 | 8000 | 7500 |
| CRI | 100 | 85 | >85 |
| Unit size (l) | 16 | 16 | 30 |
| Open aperture (mm) | 38 | 15 | 26 |

For instance, Example 1 has an excellent CRI but poor efficacy and correlated color temperature and also unit size and, consequently, weight could be much better.

The size of the complete unit (comprising lamp, gobo, lens and other optional components) could be made smaller if smaller gobos were used. Not only the gobo size (or open aperture) would be smaller, also the projection lens could be made smaller and have shorter focal length thus shortening the optical path. A smaller size would also lead to lower weight. However, if the size of the gobo was smaller also the efficacy would drop and therefore the light output. This unit is using a halogen lamp with low cost, but also low efficacy and a relatively large filament resulting in the necessity to equip the projector with large gobos to enable enough light output. Would the gobo size in example 1 be smaller, the overall efficacy would drastically decrease (see also below).

Moreover, this unit can only accommodate one gobo, as the image size is 38 mm. Multiple gobos in one so-called gobo wheel would lead to a much larger and heavier system. Making the image size much smaller would enable the use of a gobo wheel with multiple gobos, but again would lead to a much lower light output as the light output is related to the geometrical extent or etendue of the projection system, as is known to one skilled in the art.

It would therefore be desirable to have a unit with higher efficacy, higher CCT, smaller size and lower weight and having the possibility to use a gobo wheel with multiple gobos.

An improvement could be made by using a high-intensity discharge lamp instead of a halogen lamp. While halogen lamps typically have efficacies of around 20 lm/W and a CCT of around 3000 K, high-intensity discharge lamps can be made with higher efficacies of around 70-100 lm/W and CCTs of around 5000-8000 K. In general, in the art higher CCT values than 3000 K or even higher than 6000 K are desired since “perceived brightness” is important for users of the gobo projectors. Example 2 is such a system having a high(er) CCT.

Example 2 employs gobos with an image size of 15 mm and can accommodate gobo wheels with up to 12 gobos, thereby creating a larger variety of images, making the product more attractive for the application.

Compared to Example 1, the specification is improved with respect to CCT, but the rest is similar. The improvement of the CCT is directly related to the lamp, but the improvement in lamp efficacy (70 lm/W) is not visible in a higher overall efficacy (20 lm/W) (a larger open aperture in Example 2 would only have a small contribution to the overall efficacy). This is caused by the fact that the etendue of the system has dramatically shrunk from about 800 mm²sr to about 67 mm²sr as the image size of the gobo has shrunk from 38 mm to 15 mm. Light collection efficacy then dramatically reduces from about 90% to about 35%, if the arc size is about 5 mm.

Example 3 has an excellent CRI and correlated color temperature but efficacy could be better, as it is only 24 lm/W (this is calculated; the actual given figure is 18 lm/W), while the efficacy of the lamp is over 85 lm/W.

The size of the unit is also considerable. It could be made smaller if smaller gobos were used. Not only the gobo size would be smaller, also the projection lens could be made smaller and have shorter focal length thus shortening the optical path. A smaller size would also lead to lower weight. However, if the size of the gobo would be smaller also the efficacy would drop and therefore the light output.

It would therefore be desirable to have a unit with higher efficacy (overall efficacy or system efficacy), while keeping the luminous output, and with higher CCT and CRI. Furthermore, smaller size and lower weight would be nice additional advantages. It would be preferred to have a unit with higher overall efficacy, smaller size and lower weight, while preferably keeping the possibility to accommodate a gobo wheel, with e.g. 8 gobos. It is an object of this invention to propose a gobo projector (such as a moving head) with a high system efficacy. It is further an object of this invention to propose a gobo projector having a good or preferably high CRI. It is further an object of the invention to propose a gobo projector having a high CCT. It is yet further an object of the invention to propose a gobo projector having a reduced gobo open aperture.

Hence, it is an aspect of the invention to propose an alternative gobo projector, which preferably further at least partly obviates one or more of above-described drawbacks, and which preferably further fulfils one or more of the above-indicated objects.

To that end, the invention proposes in an embodiment a gobo projector comprising a light source, a gobo holder having a gobo open aperture and a projection lens, wherein the light source is a high-pressure metal halide discharge lamp having an arc length, wherein the gobo projector has an overall efficacy of at least 25 lm/W. Advantageously, such gobo projector can be relatively small, while still having a relative high efficacy. Further, such gobo projector may have a relative high CRI, relative high CCT, and may have a relative small gobo open aperture.

Preferably, the gobo projector has a light output of at least 5000 lumen, an overall efficacy of at least 25 lm/W, and a correlated color temperature of at least 5500 K. Further, preferably the gobo projector has a gobo open aperture smaller than or equal to 38 mm, more preferably smaller than or equal to 26 mm, even more preferably smaller than or equal to 15 mm. The gobo open aperture may be equal to or larger than about 5 mm, such as equal to or larger than 6 mm. The smaller the gobo open aperture (or gobo size), the less volume the gobo projector may need and/or the more gobos may be applied in the projector. Further, preferably the light output is above 10000 lumen and even more preferably above 15000 lumen. Further, preferably the efficacy is at least 35 lm/W. The color rendering index (CRI) is at least 75, preferably at least 85, especially in view of the use of a gobo projector also for illumination purposes.

Specific embodiments, especially in relation to embodiments of gobo projectors comprising UHP (ultra-high performance) lamps having a power equal to or less than 400 W are described in more detail below.

In a specific embodiment, it is especially suggested to use a short-arc lamp with high efficacy which may result in a high-luminous output, and a highly efficient, relatively small and low-weight gobo projector. Such a lamp is available in the form of a UHP lamp, as known from light valve (LCD, LCOS or DLP) projectors. These lamps may typically have an arc length of less than 1.5 mm, an overall efficacy of >60 lm/W, and are available in the range 50-400 Watt.

UHP lamps are for instance described in U.S. Pat. No. 5,109,181, U.S. Pat. No. 6,300,717 and H. Moench et al, SID Digest 2003, 16.1, which are incorporated herein by reference.

In a specific embodiment, the lamp is a high-pressure mercury vapour discharge lamp comprising a discharge envelope, a pair of discharge electrodes (comprising tungsten) between which a discharge is maintained during lamp operation, and a filling comprising mercury, a rare gas, and a halogen for maintaining a tungsten transport cycle during lamp operation, wherein the quantity of mercury is larger than 0.2 mg/mm³, during lamp operation the mercury vapour pressure is higher than 200 bar and the wall load is higher than 1 W/mm², and in that at least one of the halogens Cl, Br or I is present in a quantity between 10⁻⁶ and 10⁻² μmol/mm³, such as between 10⁻⁶ and 5.10^{-4 μ}mol/mm³. In a further embodiment, the lamp comprises a unit of an electric lamp and reflector, comprising a reflector body including a reflector part with a concave reflecting surface having an optical axis, a hollow neck-shaped portion integral with said reflector body, and a light emission window surrounding said optical axis; an electric lamp comprising a light-transmitting vessel sealed in a vacuum-tight manner, enclosing a cavity and having a first and a second mutually opposing sealed end portion, an electric element arranged in the cavity and respective current conductors connected to the electric element, extending through said sealed end portions and issuing from the lamp vessel to the exterior, the electric lamp being fixed in the reflector body with the first end portion inside the neck-shaped portion, while the cavity lies within the reflecting portion and the electric element is on the optical axis, wherein preferably the reflector body has lugs on a side nearest to the light emission window.

These lamps may typically have an arc length of less than 1.5 mm, an overall efficacy of >60 lm/W, and are available in the range of 50-400 Watt.

Using such a lamp, the gobo projector can be equipped with a gobo with an image size even as small as about 5 mm and an acceptance angle of about 25°. The smaller gobo may result in a smaller projection lens with shorter focal length and therefore in a system with a smaller size and a lower weight. The overall system efficacy can still be 40-60 lm/W.

A choice can be made to equip the gobo projector with a color wheel having multiple gobos. Due to the smaller diameter of the individual gobo, the gobo wheel can still be very limited in size.

With such UHP lamp, typically a CCT of about 7000-8000 K may be achieved. Especially, Hg pressures over 225 bar, even more preferably over 250 bar, may be beneficial with respect to the CRI. Herein, the Hg pressure is indicated as the Hg pressure at nominal power. For instance, assuming a 300 W lamp, the Hg pressure at 300 W is preferably at least 225 bar, even more preferably at least 250 bar. The Hg pressure may further be equal to or smaller than about 300 bar. Surprisingly, increasing the Hg pressure to these values increases the CRI and moreover, this CRI is maintained in the light collected into the etendue of the gobo projector.

Therefore, the invention proposes according to a further aspect a gobo projector (comprising a light source, a gobo holder having a gobo open aperture and a projection lens), wherein the light source is a high-pressure metal halide discharge lamp having an arc length, wherein the light source is preferably an ultra-high pressure lamp, preferably comprising a quartz discharge vessel, a filling comprising mercury, a rare gas and a halogen, wherein the quantity of mercury is preferably at least 0.15 mg/mm³ and the halogen preferably comprises one or more halogens selected from the group consisting of Cl, Br and I, wherein the halogen is preferably present in a quantity between 10⁻⁶ and 10⁻² μmol/mm³, such as between 10⁻⁶ and 5.10^{-4 μ}mol/mm³, and wherein preferably the arc length is smaller than 1.5 mm, such as in the range of about 0.5-1.5 mm. Such gobo projector may have an overall efficacy of at least 25 lm/W, such as at least 35 lm/W.

Preferably, the arc length is in the range of 0.5-1.5 mm. Even more preferably, the arc length is in the range of 0.-61.0 mm, yet even more preferably, the arc length is between 0.7 and 0.9 mm. Smaller arc lengths advantageously allow smaller open apertures.

Preferably, the Hg pressure inside the lamp is larger than or equal to 225 bar, such as at least about 250 bar. The Hg pressure may further be equal to or smaller than about 300 bar. Surprisingly, the relatively high Hg pressures may propose lamps with improved CRI, that is maintained in the light collected into the etendue of the gobo projector. Further, preferably the quantity of mercury is preferably in the range of 0.15-0.4 mg/mm³, such as in the range of 0.2-0.35 mg/mm³.

In an embodiment, the power supplied to the lamp is equal to or less than 400 W, such as in the range of 50-400 W.

Specific embodiments, especially in relation to embodiments of gobo projectors comprising UHP lamps having a power equal to or larger than 300 W, especially equal to or larger than 400 W, are described in more detail below.

In yet a further embodiment, also a UHP lamp may be applied, wherein the power supplied to the lamp is larger than 300 W, especially equal to or larger than 400 W, and wherein preferably the UHP lamp is a UHP lamp having a cooled discharge vessel.

Such discharge lamps are for instance described in U.S. Pat. No. 6,724,147 and U.S. Pat. No. 7,439,660, which are incorporated herein by reference. Such lamps are also indicated as CPL lamps (i.e. compact power light). Hence, preferably, the discharge lamp is a high-pressure gas discharge lamp with a cooling arrangement, wherein the lamp can be operated at an increased power level such that an increased gas pressure is generated by an increase in the temperature in the lamp interior, while the cooling arrangement is positioned and dimensioned such that a devitrification of the lamp bulb and a condensation of the filling gas are substantially prevented at said increased power level. Further, preferably, the lamp is a discharge lamp having a reflector and cooling means, which cooling means have at least one nozzle through which a flow of gas can be directed onto the discharge lamp, wherein the at least one nozzle is arranged such that it does not extend, at least to any substantial degree, into a beam path produced by the lamp and the reflector.

Therefore, in a specific embodiment, the invention proposes a gobo projector comprising a light source, a gobo holder having a gobo open aperture and a projection lens, wherein the light source is a high-pressure metal halide discharge lamp having an arc length, wherein the gobo projector preferably has an overall efficacy of at least 25 lm/W, and wherein the power of the lamp is preferably larger than 400 W, and wherein the discharge vessel is preferably cooled.

Preferably, the arc length is in the range of 0.5-1.5 mm. Even more preferably, the arc length is in the range of 0.6-1.0 mm, yet even more preferably, the arc length is between 0.7 and 0.9 mm. As mentioned above, smaller arc sizes allow smaller open apertures.

Specific embodiments, especially in relation to embodiments of gobo projectors comprising high-pressure metal halide lamps having a power equal to or higher than 300 W, such as in the range of 300-2000 W, like 400-2000 W, especially 400 W, are described in more detail below.

As CPL lamps with cooled discharge vessel are not readily available, one could instead of using UHP or CPL lamps, also just use metal halide lamps with reduced electrode distance. This may however introduce several issues.

Shortening the arc with the same power input may lead to a drop in lamp voltage and increase in lamp current. The higher lamp current will lead to a higher plasma temperature and therefore to a lower correlated color temperature. This is because the lower wavelengths leading to a high correlated color temperature are generated by atomic radiation from the centre of the arc, while the longer wavelengths are generated by molecular radiation. As plasma temperature increases, this leads to another balance between the atomic and molecular radiation, thus leading to the drop in CCT.

To avoid the effects of the increase in lamp current one may also increase the pressure inside the lamp. A shorter arc in combination with a higher pressure inside the discharge chamber may keep the lamp voltage constant and therefore the current constant at the same power level. However, also increasing the pressure may lead to a lower CCT.

Therefore, also a modified high-pressure metal halide discharge lamp is proposed for the gobo projector. The light source suggested is a high-pressure metal halide discharge lamp, with a relatively short arc and high specific power to enable a high system efficacy, but with a modified filling, that in combination with the reduced arc length still enables a high CCT and CRI. It has surprisingly been found that a filling comprising noble gas, mercury, halogen, zirconium and one or both of the elements In or Mn, (substantially) without the addition of rare earth metals, may especially in combination with a specific power over 200 W/mm and preferably a pressure over 40 bar, lead to an overall system efficacy >25 lm/W, a high CCT between 6000 and 8000 K, a CRI of over 75 and a big reduction in devitrification, leading to longer lifetimes. Lamps with other fillings with good CCT and CRI are for instance known from DE29905662, U.S. Pat. No. 5,323,085, U.S. Pat. No. 5,929,563, U.S. Pat. No. 6,380,675, EP0702394 and WO2001035443, which are herein incorporated by reference. However, these documents all refer to different fillings and/or lower specific powers.

Surprisingly we have found one does not necessarily need thallium, cesium or tin, nor any of the rear earths to achieve the good CCT and CRI.

Moreover, in some of the mentioned patents the specific power levels (power per mm electrode distance) is given to be between 50 and 90 W/mm or up to 140 W/mm. However, with a 700 W lamp in a 3 mm arc, a value >200 W/mm and with 1200 W in 4 mm a value of even 300 W/mm arc length specific power is obtained. With this combination not only the high CCT and CRI in combination with a long life can be achieved, but one may also achieve an even higher collection efficacy and therefore overall system efficacy. The higher the specific power levels, the better the overall system efficacy of the gobo projector is.

Preferably, the filling comprises at least: a noble gas; mercury; at least one halogen; zirconium, partly or wholly replaceable by hafnium; and indium, partly or wholly replaceable by manganese. Further, such lamp may have a specific power of >200 W/mm, enabling lamps with >75 lm/W, a CRI of >75, a CCT higher than or equal to 6000 K with a service life of over 750 hours. An arc length of 3 to 4 mm with the correct reflector may lead to a system with an overall system efficacy of 25-30 lm/W, especially in case that the gobo open aperture size is about 25 mm, and of about 35-40 lm/W for an open aperture size of 37.5 mm. Preferably, the filling at least comprises zirconium, especially when aiming at a high CCT. In an embodiment, the pressure is in the range of 40-70 bar, such as 40-60 bar; in another embodiment, the pressure is at least 45 bar.

As these lamps can be made with power levels of over 300 Watt, such as 400-2000 Watt, gobo projectors can be made with a 25 mm gobo open aperture size, a 25 lm/W overall system efficacy, 10000-50000 lm system output, a CRI of >75, and a CCT >5500 K. Also systems can be made with a 37.5 mm gobo open aperture size, a 35 lm/W overall system efficacy, 15000-75000 lm system output, a CRI of >75, and a CCT >5500 K.

Therefore, the invention also proposes a gobo projector comprising a light source, a gobo holder having a gobo open aperture and a projection lens, wherein the light source is a high-pressure metal halide discharge lamp having an arc length, wherein the gobo projector preferably has an overall efficacy of at least 25 lm/W, wherein the light source is a high-pressure metal halide discharge lamp, comprising a quartz discharge vessel, a filling comprising mercury, one or more selected from the group consisting of zirconium and hafnium, a rare gas, metals selected from the group consisting of manganese and indium, and halogen, wherein halogen preferably comprises one or more halogens selected from the group consisting of Cl, Br and I, and preferably having a specific power (i.e. power (W)/arc length (mm)) of at least 200 W/mm. At nominal pressure during operation, at least part of the constituents of the filling is ionized. In an embodiment, at least part of the total amount of one or more metals may be introduced in the vessel as metal-halides. The arc length may also be indicated as “short arc length”.

Preferably, the lamp power is in the range of 400-2000 W. Further, advantageously, the arc length is in the range of 2.5-4 mm, especially around about 3 mm. Yet preferably, the gobo projector has a specific power (power (W)/arc length (mm)) of at least 200 W/mm. In an embodiment, the specific power may be equal to or smaller than about 1000 W/mm, such as equal to or smaller than about 500 W/mm.

Below, embodiments are described in more detail, wherein the gobo projector (such as a moving head) further comprises a homogenizing device.

The use of, especially, axially oriented UHP lamps as proposed above may result in an inhomogeneous light distribution on the gobo and therefore on the image. A further preferred embodiment of the gobo projection system is therefore to equip the system with a homogenizing device such as a fly's eye integrator, a light tunnel or an integrating rod.

Gobo projectors often have round (circular) gobos. The integrating means should therefore preferably enable the homogeneous illumination of a circle while maintaining a high efficacy. A circular cross-section however gives poor homogenization results. A rectangular or square cross-section gives good homogeneity but some light is lost. With a square cross-section of the integrating rod or light tunnel the maximum inscribed circle covers π/4≈78% of the area of the cross-section, meaning that 22% of the light is lost.

Would the light tunnel or integrating rod have a hexagonal cross-section, the inscribed circle covers π*√3/6≈91% of the area of the tunnel/rod, meaning that only 9% of the light is lost. Other polygonal cross-sections can also be considered, but it appears that good uniformity and efficacy is only possible if one can completely fill a plane with these polygons, as is the case for triangles, squares, and hexagons, but not for circles, pentagons, octagons, etc.

Therefore, the invention further proposes a gobo projector as amongst others defined above, further comprising a homogenizing device arranged for homogenizing the illumination distribution of the light source on the gobo open aperture, the homogenizing device being arranged downstream of the light source and upstream of the gobo aperture. In an embodiment, the homogenizing device is an integrating rod, such as preferably made out of (one or more) materials selected from the group consisting of glass, quartz, transparent ceramic and transparent plastic. In yet a further embodiment, the homogenizing device is an integrating tunnel. In yet a further embodiment, the homogenizing device is a fly's eye. Preferably, the homogenizing device comprises a cross-section selected from the group consisting of regular triangle, square, and regular hexagon, preferably a regular hexagon.

In a preferred embodiment, the gobo projector further comprising a color filter holder (comprising one or more color filters), such as preferably a color wheel, arranged downstream of the light source and upstream of the gobo holder.

The optical system inside a gobo projector preferably minimally consists of a light source, a gobo holder arranged to hold a gobo, optionally a gobo, and a projection lens. In addition to that, the optical system can preferably also comprise one or more (dichroic) (interchangeable) color filters, one or more (dichroic) (interchangeable) (color) mirrors, mechanical dimming means, means for collecting the light from the light source and redirecting it through the gobo image field and projection lens, additional gobos (such as when using a gobo wheel), additional light sources and even additional projection lenses.

The invention also relates to so-called moving heads, basically gobo projectors held in a yoke such that they can be tilted and rotated in any direction by sending the appropriate signals to the moving head.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 schematically depicts an embodiment of a gobo projector;

FIGS. 2a-2f schematically depict some aspects of a gobo projector according to the invention; and

FIGS. 3a-3b schematically depict results with a gobo projector according to embodiments of the invention.

### DESCRIPTION OF PREFERRED EMBODIMENTS

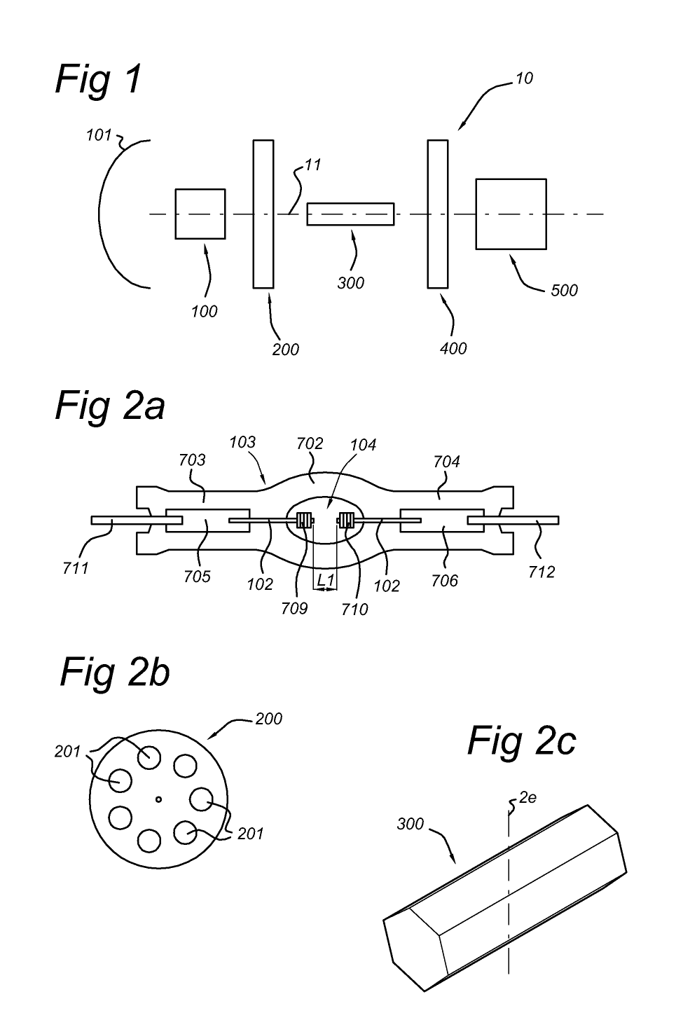

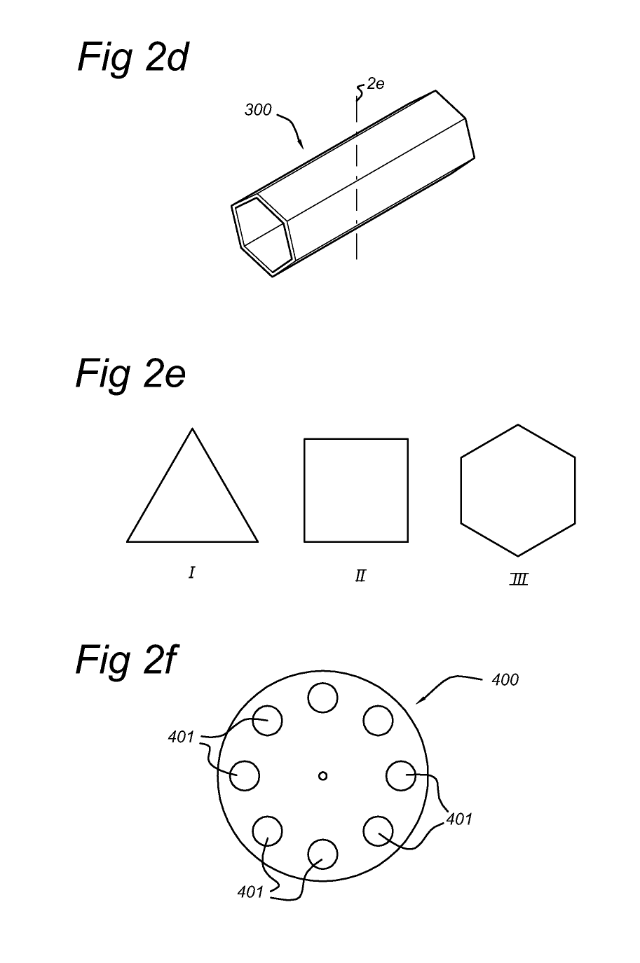

FIG. 1 schematically depicts a gobo projector 10 comprising a light source 100, a gobo holder 400 having a gobo open aperture 401 (see also FIG. 2f) and a projection lens 500. The light source 100 may further comprise a reflector 101, preferably arranged to collimate light of the light source 100 in the direction of the gobo holder 400. The gobo open aperture 401 is in general the diameter of the gobo in the gobo holder 400.

The terms “upstream” and “downstream” relate to an arrangement of items or features relative to the propagation of the light from a light generating means (here light source 100), wherein relative to a first position within a beam of light from the light generating means, a second position in the beam of light closer to the light generating means is “upstream”, and a third position within the beam of light further away from the light generating means is “downstream”.

Here, the gobo holder 400 is arranged downstream of the light source 100. Further, the projection lens 500 is arranged downstream of the gobo holder 400; whereas the gobo holder 400 is arranged upstream of the projection lens 500. The gobo holder 400 is arranged to hold one or more gobos. The gobo holder 400 may be a gobo wheel (see also below).

Further, the gobo projector 10 may comprise a color filter holder 200 (see also FIG. 2b), especially a color wheel. The color filter holder 200 is preferably arranged downstream of the light source 100 and upstream of the gobo holder 400.

In addition, the gobo projector 10 may comprise a homogenizing device 300, such as an integrating rod or an integrating tunnel. The homogenizing device 300 is preferably arranged upstream of the gobo holder 400 and downstream of the light source 100. In case a color filter holder 200 is part of the gobo projector 10, preferably, the homogenizing device 300 is arranged downstream of the color filter holder and upstream of the gobo holder 400.

For the sake of clarity, an optical axis 11 is depicted. The optical axis 11 may coincide with a longitudinal axis of the homogenizing device 300 and/or of the projection lens 500. The gobo holder 400 and the color filter holder 200 are preferably arranged to allow the optical axis 11 to pass through the centre of a gobo open aperture 401 (in a gobo holder 400, such as a gobo wheel) and of an optional color filter 201 (see below) (in a color filter holder 200, such as a color wheel), respectively.

Preferably, the gobo projector 10 has an overall efficacy of at least 25 lm/W. FIG. 2a schematically depicts a discharge vessel 103, having an envelope 702 of quartz glass. The envelope ends are adjoined by quartz parts 703 and 704, into which (molybdenum) foils 705 and 706 are sealed in a vacuum-tight manner. The inner ends of the molybdenum foils 705 and 706 are connected to electrodes 102, which may carry wrappings or coils 709 and 710. The outer ends of the molybdenum foils 705 and 706 are adjoined by current supply wires 711 and 712 (of molybdenum) extending to the exterior. The distance between the electrodes is indicated with reference L1.

As mentioned above, the light source 100 (see also FIG. 1), which may comprise the discharge vessel as schematically indicated in FIG. 2a, is preferably a high-pressure metal halide discharge lamp. Reference 104 indicates the volume of the discharge vessel 103, which may contain one of the above-defined specific fillings (see the summary).

FIG. 2b schematically depicts color filter holder 200 as color wheel, comprising a plurality of (different) color filters 201.

FIGS. 2c-2d schematically depict embodiments of the optional homogenizing device 300, wherein the former displays a massive device (rod with, for example, a hexagonal cross-section) and the latter displays a hollow device (tube with, for example, a hexagonal cross-section). FIG. 2e schematically depicts preferred cross-sections of the homogenizing device, i.e. triangular (I), square (II) or hexagonal (III). Especially a hexagonal cross-section of the homogenizing device 300 is preferred. Cross-section III may correspond to the cross-section of the embodiments depicted in FIGS. 2c and 2d.

FIG. 2f schematically depicts gobo holder 400 as gobo wheel, comprising a plurality of (different) gobos or gobo open apertures 401. The gobo wheel is especially arranged to hold a plurality if gobos (the gobo open aperture 401 has essentially the diameter of the gobo in the gobo holder 400).

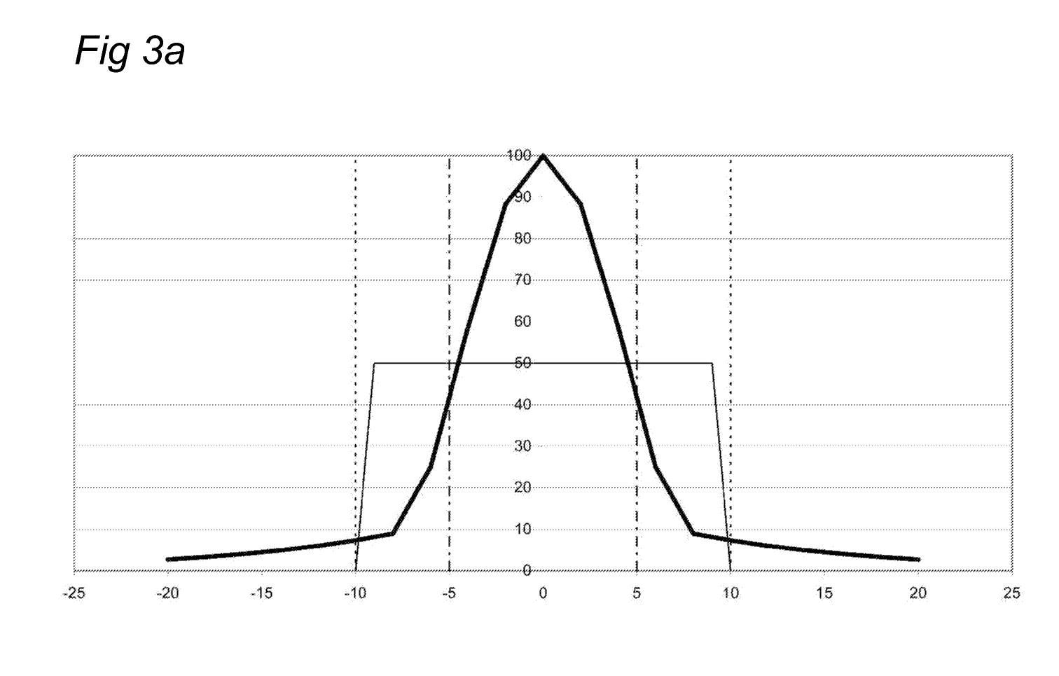

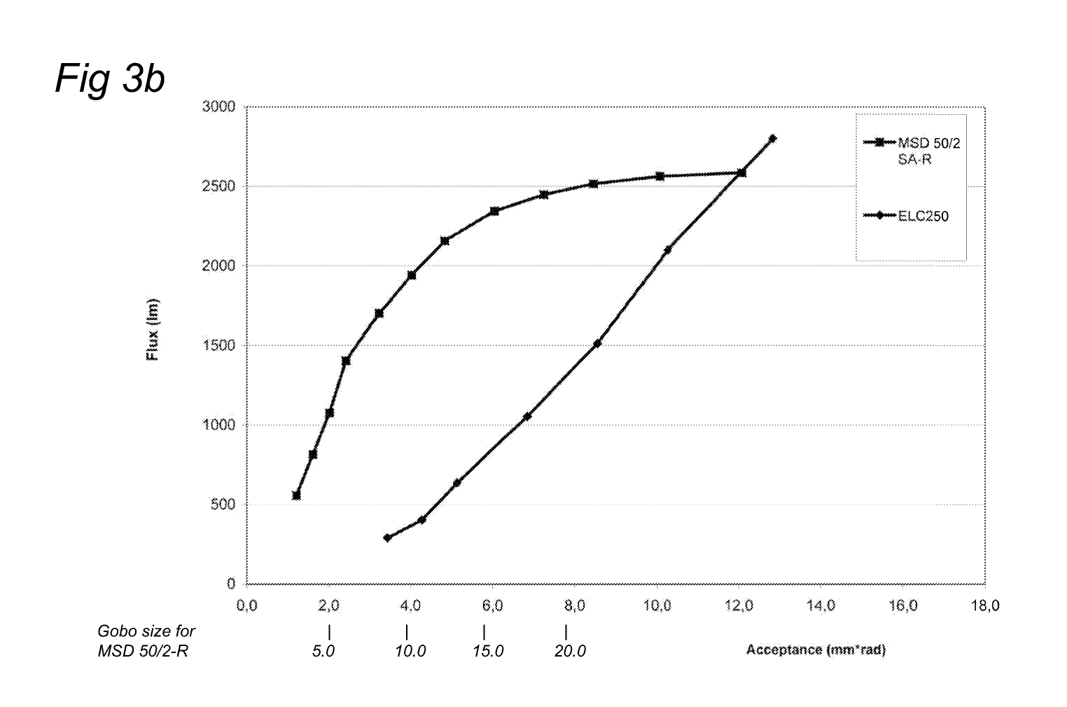

FIG. 3a schematically depicts the light distribution at the gobo, especially when using an axially-oriented short-arc lamp as light source 100. The x-axis indicates a cross-section across the beam in arbitrary units. If the gobo size is −5-+5 (the dot-dashed lines at −5/5 in FIG. 3a), the homogeneity is relatively good (about 40%), but the efficacy may be relatively poor as a result of light loss. Assuming however a gobo having a size −10-+10 (the dashed lines at −10/10 in FIG. 3a), the efficacy is good (substantially no light loss), but the homogeneity is relatively poor (smaller than about 10%). However, using an homogenization device, such as described above, both homogeneity and efficacy may be relatively good. The latter embodiment is schematically depicted with the “square” from -31 10-+10 at a height of 50%.

FIG. 3b depicts an example of the collected flux (in lumen) as a function of acceptance (in mm*rad) (the upper values along the x-axis). The lower curve is a curve for a prior-art light source, whereas the upper curve is the curve for a gobo projector with an above-defined UHP source (arc length L1=1 mm). For comparison, aperture values are also indicated (the lower values along the x-axis).

The term “substantially” herein, such as in “substantially all emission” or in “substantially consists”, will be understood by the person skilled in the art. The term “substantially” may also include embodiments with “entirely”, “completely”, “all”, etc. Hence, in embodiments the adjective “substantially” may also be removed. Where applicable, the term “substantially” may also relate to 90% or higher, such as 95% or higher, especially 99% or higher, even more especially 99.5% or higher, including 100%. The term “comprise” includes also embodiments for which the term “comprises” means “consists of”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A gobo projector (10) comprising a light source (100), a gobo holder (400) having a gobo open aperture (401), and a projection lens (500), wherein the light source (100) is a high-pressure metal halide discharge lamp having an arc length (L1), wherein the gobo projector has an overall efficacy of at least 25 lm/W.

2. The gobo projector (10) according to claim 1, wherein the arc length (L1) is in the range of 0.5-4 mm.

3. The gobo projector (10) according to claim 1, having a light output of at least 5000 lumen, an overall efficacy of at least 25 lm/W, and a correlated color temperature of at least 5500 K.

4. The gobo projector (10) according to claim 1, wherein the color rendering index (CRI) is at least 75.

5. The gobo projector (10) according to claim 1, having a gobo open aperture (401) smaller than or equal to 26 mm, preferably smaller than or equal to 15 mm.

6. The gobo projector (10) according to claim 1, having an overall efficacy of at least 35 lm/W.

7. The gobo projector (10) claim 1, wherein the light source (100) is an ultra-high pressure lamp comprising a quartz discharge vessel, a filling comprising mercury, a rare gas and a halogen, wherein the quantity of mercury is preferably at least 0.15 mg/mm³ and the halogen preferably comprises one or more halogens selected from the group consisting of Cl, Br and I, wherein the halogen is preferably present in a quantity between 10⁻⁻⁶ and 10⁻² μmol/mm³, and wherein the arc length (L1) is smaller than 1.5 mm.

8. The gobo projector according to claim 7, wherein the arc length (L1) is smaller than 0.9 mm.

9. The gobo projector according to claim 7, wherein the Hg pressure inside the lamp is larger than or equal to 225 bar.

10. The gobo projector (10) according to claim 1, wherein the light source (100) is a high-pressure metal halide discharge lamp comprising a quartz discharge vessel, a filling comprising mercury, one or more metals selected from the group consisting of zirconium and hafnium, a rare gas and metals selected from the group consisting of manganese and indium, and halogen, wherein halogen preferably comprises one or more halogens selected from the group consisting of Cl, Br and I, and having a specific power (power (W)/arc length (mm)) of at least 200 W/mm.

11. The gobo projector (10) according to claim 1, further comprising a homogenizing device (300) arranged for homogenizing the illumination distribution of the light source (100) on the gobo open aperture (401), arranged downstream of the light source (100) and upstream of the gobo aperture (401).

12. The gobo projector according to claim 11, characterized in that the homogenizing device (300) is an integrating rod made of one or more materials selected from the group consisting of quartz, glass, transparent ceramic, and transparent plastic.

13. The gobo projector according to claim 11, characterized in that the homogenizing device is an integrating tunnel.

14. The gobo projector according claim 12, wherein the homogenizing device (300) comprises a cross-section selected from the group of regular triangle, square, and regular hexagon, which latter is preferred.

15. A moving head comprising a yoke in which is held a gobo projector according to claim 1.
